(19) United States
(12) Patent Application Publication
(10) Pub. No.: US 2010/0290159 A1
(43) Pub. Date: Nov. 18, 2010

(54) Common tray for head gimbal assembly and common tray assembly with the same

(75) Inventors: Shenkuang S. Chou, Hong Kong (CN); Kayip Wong, Hong Kong (CN); Chihung Yuen, Hong Kong (CN); ShuMing Zhang, Dongguan (CN); Yuanjin Xu, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (HK)

(21) Appl. No.: 12/453,675

(22) Filed: May 18, 2009

(51) Int. Cl. G11B 5/48

(52) U.S. Cl. 360/245; G9B/5.147

(57) ABSTRACT

A common tray for HGA comprises a frame, a first inner bar, and a second inner bar parallel to and spaced from the first inner bar. Ends of the first and second inner bars connect to the opposite edges of the frame. A plurality of locating pillars and a plurality pairs of first bumps are uniformly-spaced formed on the first inner bar respectively. The first inner bar has portions between each said pair of first bumps recessed for forming spaces under the HGA. A plurality of second bumps are uniformly-spaced formed on the second inner bar for withstanding an edge of the base plate. The present common tray can replace five kinds of trays traditionally used in the HGA manufacturing process, and thus reduce the load/unload operations as well as the no-value stations and operators, thereby the productive efficiency is improved, and manufacturing cost is reduced.

### FIELD OF THE INVENTION

The present invention relates generally to a device for fabricating hard disk drives, and more particularly to a common tray for HGA (Head Gimbal Assembly) and common tray assembly.

### BACKGROUND OF THE INVENTION

Disk drives are information storage devices that use thin film magnetic media to store data. A typical disk drive comprises a head stack assembly (HSA) with one or several head gimbal assemblies (HGAs) having slider(s) thereon, a magnetic disk mounted on a spindle motor which causes the magnetic disk to spin, and a motor base to enclose the above-mentioned components. The slider(s) flies over the surface of the magnetic disk at a high velocity to read data from or write data to concentric data tracks on the magnetic disk, which is positioned radially by an ACA (arm coil assembly) embedded (e.g. by epoxy potting or overmolding) in a fantail spacer of the HSA. Generally, a voice coil motor (VCM) is used to drive the ACA.

A traditional HGA is a very precision and critical part in the disk drive, so frequent cleaning and inspection/testing of the HGA, such as slider and FPC (flexible printed circuit) of the HGA are required during the whole HGA manufacturing process. As shown in FIG. 1, a traditional HGA manufacturing process includes the following steps: (11) shifting suspension from suspension tray to a metal holder (the metal holder should be positioned by a holder tray further for electrical isolation); (12) assembling the suspension with slider to form a HGA on the metal holder; (13) shifting the HGA from the metal holder to a cleaning tray; (14) the cleaning tray carrying the HGA and cleaning the HGA for the first time; (15) shifting the HGA from the cleaning tray to a shipment tray; (16) inspecting/testing the HGA while carried on the shipment tray; (17) shifting the HGA from the shipment tray to the cleaning tray; (18) the cleaning tray carrying the HGA and cleaning the HGA for the second time.

As indicated above, the whole HGA manufacturing process needs five kinds of trays, such as suspension tray, metal holder, holder tray, shipment tray, and cleaning tray. The trays used in the prior HGA manufacturing process are generally vacuum forming trays which are easily contaminated, such as forming burrs, metal particles and black particles. In order to meet the cleaning requirement, the trays must be cleaned before the HGAs are loaded to them. That is, the trays and the HGAs have to be cleaned separately. All these cause a high cost. Further, the HGA is loaded/unloaded so many times that much no-value stations and operators are needed in the process and that sharply reduce productive efficiency.

Hence, a need has arisen for providing a common tray for HGA and a common tray assembly with the same to overcome the above-mentioned drawbacks.

### SUMMARY OF THE INVENTION

Accordingly, an object of the present invention is to provide a common tray for HGA to simplify the HGA manufacturing process, reduce cost, and increase productive efficiency.

To achieve the above-mentioned object, the present invention provides a common tray for head gimbal assembly. The common tray comprises a frame having at least two opposite edges, a first inner bar, and a second inner bar parallel to and spaced from the first inner bar. Ends of the first and second inner bars connect to the opposite edges. A plurality of locating pillars and a plurality pairs of first bumps are uniformly-spaced formed on the first inner bar respectively, each locating pillar is adapted for inserting into a locating hole of the head gimbal assembly, and each pair of first bumps is adapted for retaining the head gimbal assembly therebetween. The first inner bar has portions between each said pair of first bumps recessed for forming spaces under the head gimbal assembly. The second inner bar is adapted for supporting a base plate of the head gimbal assembly, and a plurality of second bumps are uniformly-spaced formed on the second inner bar for withstanding an edge of the base plate.

Preferably, a plurality of location pins or location holes are formed on the second inner bar, and the location pins or location holes are adapted for robot hand positioning.

Also preferably, the common tray further comprises a third inner bar, the third inner bar is parallel to and spaced from the first and the second inner bars, ends of the third inner bar connect to the opposite edges, the third inner bar is adapted for supporting a flexible printed circuit (FPC) of the head gimbal assembly.

In the invention, a plurality of protection pillars are uniformly-spaced formed on the third inner bar, and the protection pillars are adapted for preventing another common tray on said common tray from pressing the flexible printed circuit of the head gimbal assembly.

Preferably, a surface of the third inner bar is an inclined surface and the inclined surface is adapted for preventing the flexible printed circuit from pasting the third bar.

Also preferably, a plurality of third bumps are uniformly-spaced formed on the third inner bar, and each third bump is adapted for controlling tail of the flexible printed circuit from crimping relative to another common tray on the common tray and preventing electro-static discharge.

A common tray assembly for head gimbal assembly comprises a plurality of common trays, each common tray comprises a frame having at least two opposite edges, a first inner bar, and a second inner bar parallel to and spaced from the first inner bar. Ends of the first and second inner bars connect to the opposite edges. One side of the frame forms at least one protrusion, and an opposite side of the frame defines at least one cutout such that the plurality of common trays are able to be stacked by aligning and engaging the protrusion of one of the common tray with the cutout of another common tray. A plurality of locating pillars and a plurality pairs of first bumps are uniformly-spaced formed on the first inner bar respectively, each locating pillar are adapted for inserting into a locating hole of HGA, and each pair of first bumps is adapted for retaining the HGA therebetween. The first inner bar has portions between each said pair of first bumps recessed for forming spaces under the HGA. The second inner bar is adapted for supporting a base plate of the HGA, and a plurality of second bumps are uniformly-spaced formed on the second inner bar for withstanding an edge of the base plate.

In comparison with the prior art, the plurality of locating pillars, the plurality pairs of first bumps and second bumps assist to accurately position the head gimbal assembly, and the spaces formed between each pair of first bumps facilitate to clean the HGA. The structure of the common tray enables the common tray to replace five kinds of trays traditionally used in the HGA manufacturing process, and thus the load/unload operations of the HGA can be reduced, that is, the no-value stations and operators could be reduced. Thereby the productive efficiency is improved, and simultaneity manufacturing cost is reduced.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

The accompanying drawings facilitate an understanding of the various embodiments of this invention. In such drawings:

FIG. 1 is a flowchart of a traditional manufacturing process of a HGA;

FIG. 2 is a perspective view of a common tray assembly in accordance with the present invention;

FIG. 3 is a perspective view of a common tray of the common tray assembly shown in FIG. 2;

FIG. 4 is a sectional view of the common tray taken along line IV-IV of FIG. 3;

FIG. 5 is a side plan view of the common tray assembly seen from arrowed direction B1 of FIG. 2, with HGA carried on the common tray assembly;

FIG. 6 is a sectional view of the common tray assembly taken along line V-V of FIG. 2, with HGA carried on the common tray assembly;

FIG. 7 is a top plan view of the common tray shown in FIG. 3 with two explanatory HGAs carried thereon;

FIG. 8 is a partial, enlarged view of the HGA positioned on the common tray shown in FIG. 7;

FIG. 9 is a view of the HGA positioned on the common tray shown in FIG. 8 when seen from rear; and

FIG. 10 is a flowchart of the method of fabricating a HGA of disk drive devices using the common tray according to the present invention.

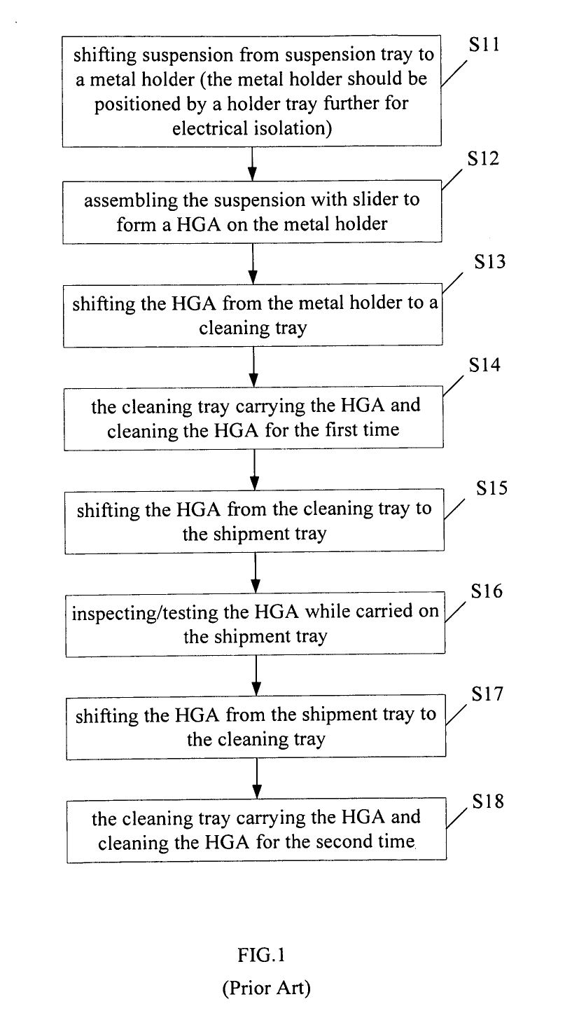

### DETAILED DESCRIPTION OF ILLUSTRATED EMBODIMENTS

Various preferred embodiments of the invention will now be described with reference to the figures, wherein like reference numerals designate similar parts throughout the various views. As indicated above, the invention is directed to a common tray and a common tray assembly, which can replace five kinds of trays traditionally used in the HGA manufacturing process, for carrying, cleaning and testing HGA of the hard disk drives. Thus, they reduce tray cost, simplify manufacturing process and increase productive efficiency. This will be described in great detail hereinafter.

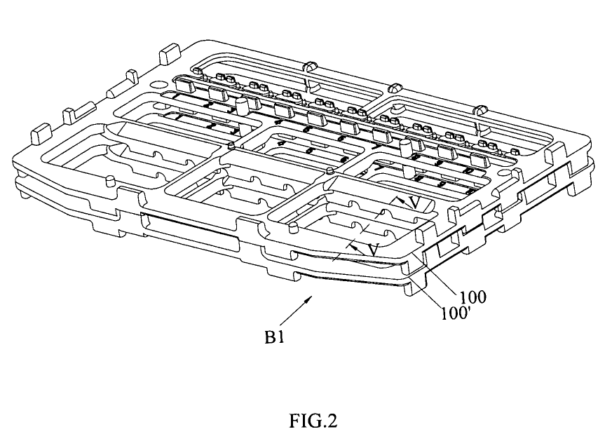

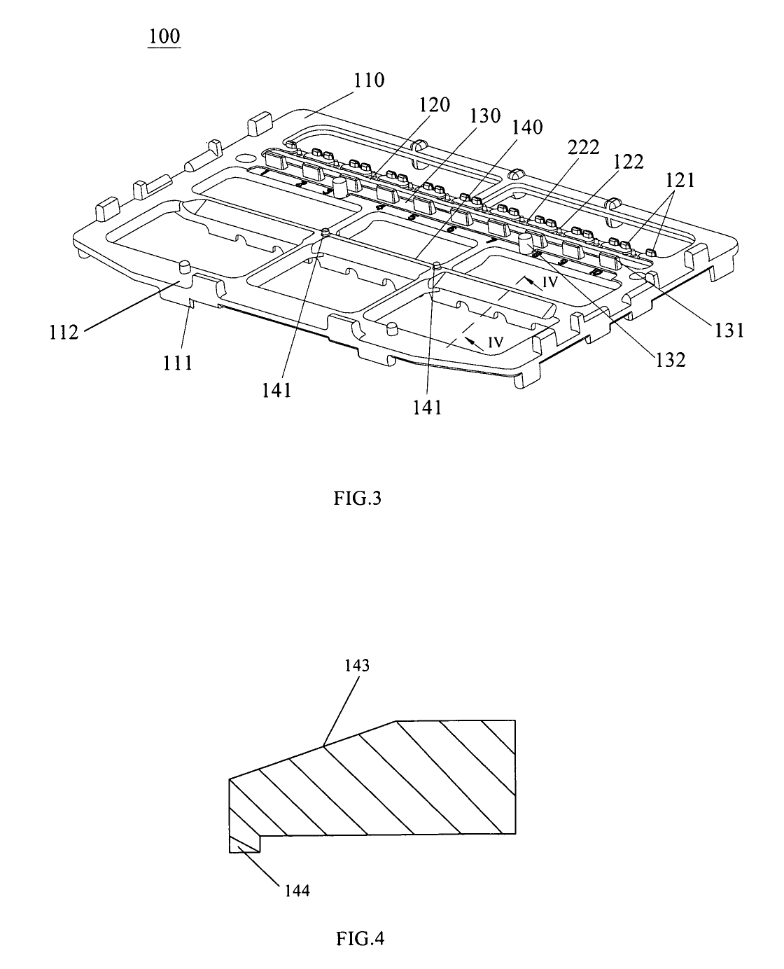

As shown in FIG.2, the present common tray assembly for HGA comprises a plurality of common trays of the same structure. In the embodiment, the common tray assembly comprises two common trays 100, 100′ stacked. The following will illustrate the structure of the common tray 100. Referring to FIG. 3, the common tray 100 comprises a frame 110 having at least two opposite edges, a first inner bar 120, a second inner bar 130 and a third inner bar 140. One side of the frame 110 forms at least one protrusion 111, and an opposite side of the frame 110 defines at least one cutout 112 such that the plurality of common trays are able to be stacked by aligning and engaging the protrusion 111 of the common tray 100′ with the cutout 112 of the common tray 100, in which way the common tray 100′ is positioned on and assembled with the common tray 100. The first inner bar 120, the second inner bar 130 and the third inner bar 140 are parallel to and spaced from each other and the second inner bar 130 is located between the first inner bar 120 and the third inner bar 140. Ends of the first inner bar 120, the second inner bar 130 and the third inner bar 140 connect to the two opposite edges of the frame 110.

A plurality of locating pillars 122 and a plurality pairs of first bumps 121 are uniformly-spaced formed on the first inner bar 120 respectively. Each locating pillar 122 is adapted for inserting into a locating hole of the HGA. Each pair of first bumps 121 is adapted for retaining the HGA therebetween. The first inner bar 120 has portions 222 between each pair of first bumps 121 recessed for forming spaces under the HGA.

The second inner bar 130 is adapted for supporting a base plate of the HGA. A plurality of second bumps 131 are uniformly-spaced formed on the second inner bar 130 for withstanding an edge of the base plate. In addition, a plurality of location pins 132 are formed on the second inner bar 130 and the location pins 132 are adapted for robot hand positioning the common tray 100. It is understood that the frame 110 or the first inner bar 120 also could form location pins. Alternatively, the location pins 132 could be replaced with location holes and the location holes are also used for robot hand positioning the common tray 100.

The third inner bar 140 is adapted for supporting a FPC of the HGA. A plurality of protection pillars 141 are uniformly-spaced formed on the third inner bar 140. The protection pillars 141 are adapted for preventing another common tray 100′ on the common tray from pressing the FPC of the HGA. FIG. 4 is a sectional view of the common tray taken along line IV-IV of FIG. 3. Referring to FIG. 4, a surface of the third inner bar 140 is an inclined surface 143. The inclined surface 143 is designed to prevent tail of the FPC from pasting to the third inner bar 140. A plurality of third bumps 144 are uniformly-spaced formed on the third inner bar 140, and each third bump 144 is adapted for controlling the tail of the FPC from crimping relative to the common tray 100′ which is formed on the common tray 100 and further preventing the FPC from ESD.

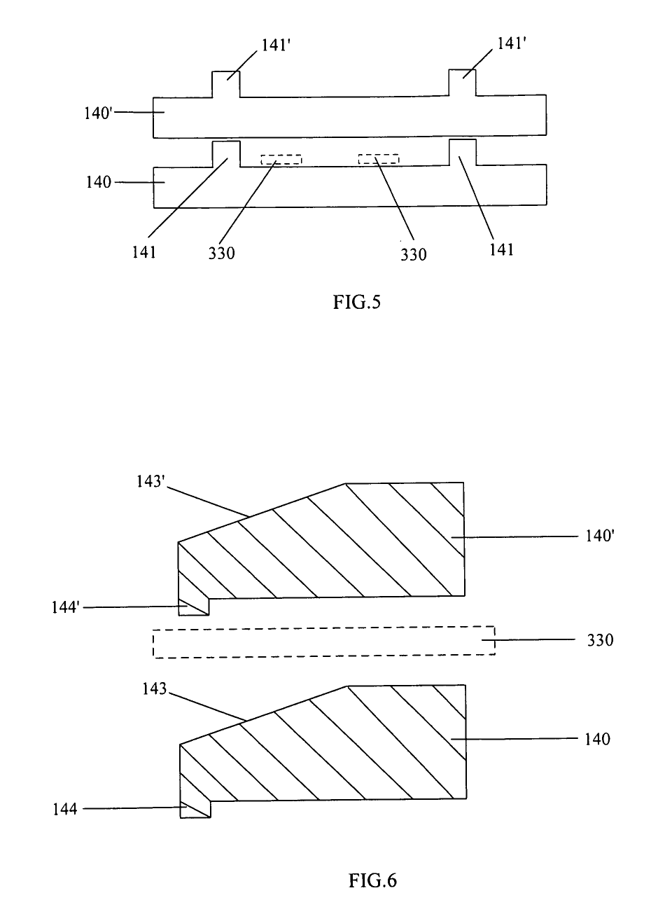

FIG. 5 is a side plan view of the common tray assembly seen from arrowed direction B1 of FIG. 2. Specifically referring to FIG. 5, a third inner bar 140′ of the common tray 100′ is formed on a third inner bar 140 of the common tray 100 with protection pillars 141 of the third inner bar 140 supporting the third inner bar 140′, thus a FPC 330 of the HGA positioned on third inner bar 140 of the common tray 100 could be avoided of pressed by the third inner bar 140′ of the common tray 100′. FIG. 6 is a sectional view of the common tray assembly taken along line V-V of FIG. 2, Referring to FIG. 6, a third inner bar 140′ of the common tray 100′ is formed on a third inner bar 140 of the common tray 100 with the third bump 144′ of the third inner bar 140′ extend to the third inner bar 140 and the inclined surface 143 of the third inner bar 140 gradually apart from the inner bar 140′, thus the FPC 330 of the HGA positioned on third inner bar 140 of the common tray 100 could be avoided of tail pasting to the third inner bar 140 and tail crimping relative to the third inner bar 140′, thereby preventing the FPC 330 from ESD.

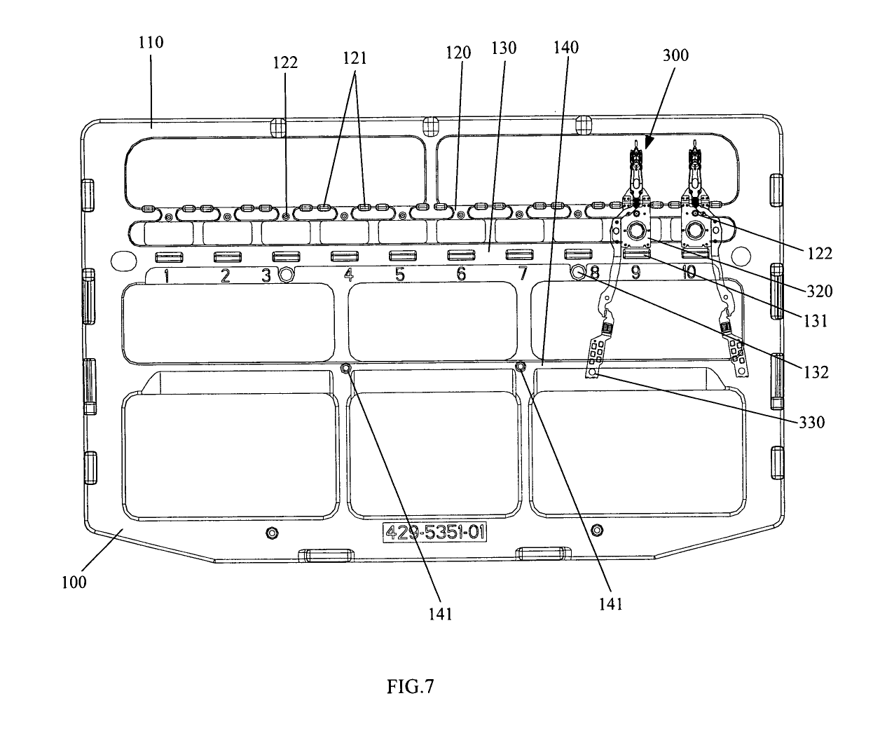

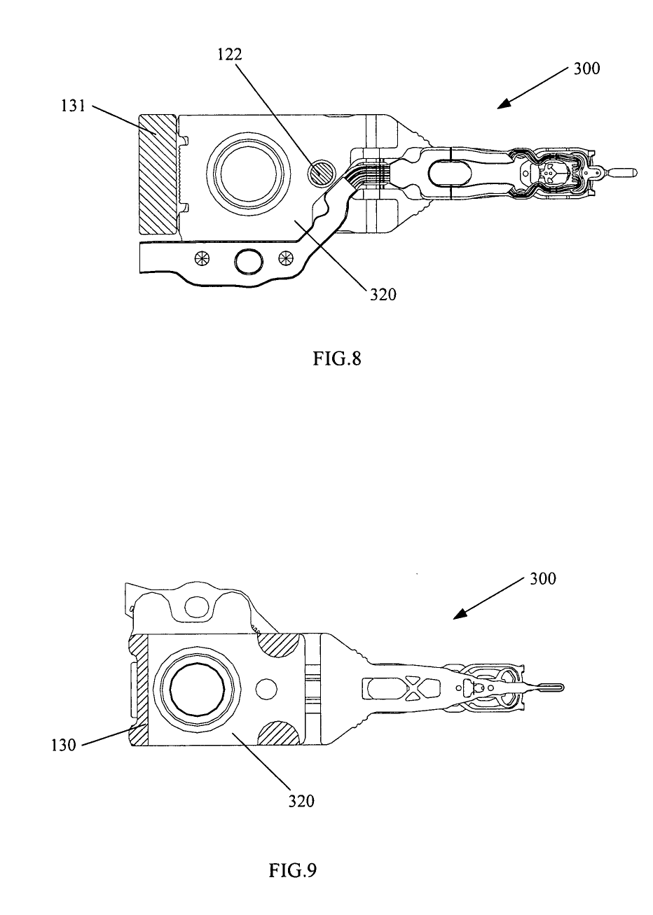

Referring to FIG. 7-9, the HGA 300 is assembled on the common tray 100. Specifically, the locating pillar 122 inserts into a locating hole of the HGA 300 and the pair of first bumps 121 retains the HGA 300 therebetween. The second bump 131 withstands edge of a base plate 320 of the HGA 300. The locating pillar 122, the pair of first bumps 121 and second bump 131 assist to accurately position the head gimbal assembly 300. The recessed portion 222 between each pair of first bumps 121 together with the HGA 300 form space under the HGA 300. The space facilitates to clean the HGA 300. The third inner bar 140 supports a FPC 330 of the HGA 300 in a way mentioned above, thus the FPC 300 is soundly protected.

Returning to FIG. 7, the common tray 100 provides a number mark corresponding to the second bump 131 to mark the HGA manufacturing follow.

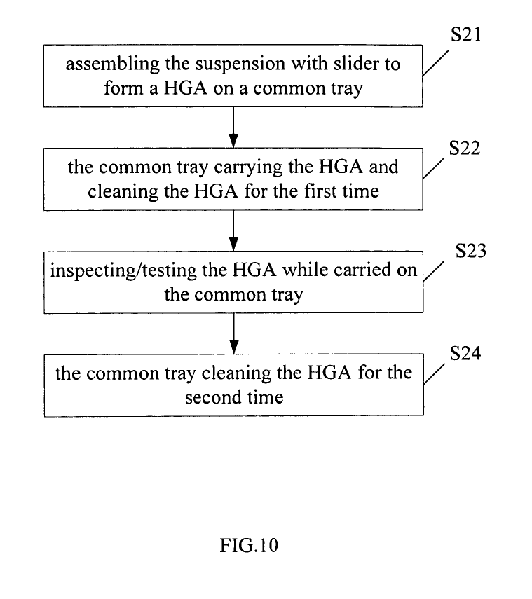

Referring to FIG. 10, the method of fabricating a HGA of a disk drive device using the above-mentioned common tray comprises the steps of: (21) assembling the suspension with slider to form a HGA on a common tray; (22) the common tray carrying the HGA and cleaning the HGA for the first time; (23) inspecting/testing the HGA while carried on the common tray; (24) the common tray cleaning the HGA for the second time.

In comparison with the prior art, the common tray can replace five kinds of trays traditionally used in the HGA process, thus the load/unload operations of the HGA can be reduced, that is, the no-value stations and operators could be reduced. Thereby the productive efficiency is improved, and simultaneity manufacturing cost is reduced.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A common tray for head gimbal assembly comprising:
a frame having at least two opposite edges, a first inner bar, and a second inner bar parallel to and spaced from the first inner bar, ends of the first and second inner bars connecting to the opposite edges;
a plurality of locating pillars and a plurality pairs of first bumps being uniformly-spaced formed on the first inner bar respectively, each said locating pillar being adapted for inserting into a locating hole of HGA, and each said pair of first bumps being adapted for retaining the HGA therebetween, the first inner bar having portions between each said pair of first bumps recessed for forming spaces under the HGA; and the second inner bar being adapted for supporting a base plate of the HGA, and a plurality of second bumps being uniformly-spaced formed on the second inner bar for withstanding an edge of the base plate.

2. The common tray according to claim 1, wherein a plurality of location pins or location holes are formed on the second inner bar, and the location pins or location holes are adapted for robot hand positioning.

3. The common tray according to claim 1, further comprising a third inner bar, the third inner bar parallel to and spaced from the first and second inner bars, ends of the third inner bar connecting to the opposite edges, the third inner bar being adapted for supporting a flexible printed circuit of the head gimbal assembly.

4. The common tray according to claim 3, wherein a plurality of protection pillars are uniformly-spaced formed on the third inner bar, and the protection pillars are adapted for preventing another common tray on said common tray from pressing the flexible printed circuit of the head gimbal assembly.

5. The common tray according to claim 3, wherein a surface of the third inner bar is an inclined surface and the inclined surface is adapted for preventing tail of the flexible printed circuit from pasting to the third inner bar.

6. The common tray according to claim 3, wherein a plurality of third bumps are uniformly-spaced formed on the third inner bar, and each third bump is adapted for controlling tail of the flexible printed circuit from crimping relative to another common tray on said common tray and preventing electro-static discharge.

7. A common tray assembly for head gimbal assembly comprising:
a plurality of common trays, each common tray comprising a frame having at least two opposite edges, a first inner bar, and a second inner bar parallel to and spaced from the first inner bar, ends of the first and second inner bars connecting to the opposite edges, one side of the frame forming at least one protrusion, and an opposite side of the frame defining at least one cutout such that the plurality of common trays are able to be stacked by aligning and engaging the protrusion of one of the common tray with the cutout of another common tray,
a plurality of locating pillars and a plurality pairs of first bumps being uniformly-spaced formed on the first inner bar respectively, each said locating pillar being adapted for inserting into a locating hole of the HGA, and each said pair of first bumps being adapted for retaining the HGA therebetween, the first inner bar having portions between each said pair of first bumps recessed for forming spaces under the HGA; and the second inner bar being adapted for supporting a base plate of the HGA, and a plurality of second bumps being uniformly-spaced formed on the second inner bar for withstanding an edge of the base plate.

8. The common tray assembly according to claim 7, wherein a plurality of location pins or location holes are formed on the second inner bar, and the location pins or location holes are adapted for robot hand positioning.

9. The common tray assembly according to claim 7, wherein each common tray comprises a third inner bar, the third inner bar are parallel to and spaced from the first and second inner bars, ends of the third inner bar connects to the opposite edges, the third inner bar are adapted for supporting a flexible printed circuit of the HGA.

10. The common tray assembly according to claim 9, wherein a plurality of protection pillars are uniformly-spaced formed on the third inner bar, and the protection pillars are adapted for preventing another common tray on said common tray from pressing the flexible printed circuit of the HGA.

11. The common tray assembly according to claim 9, wherein a surface of the third inner bar is an inclined surface and the inclined surface is adapted for preventing tail of the flexible printed circuit from pasting to the third inner bar.

12. The common tray assembly according to claim 9, wherein a plurality of third bumps are uniformly-spaced formed on the third inner bar, and each third bump is adapted for controlling tail of the flexible printed circuit from crimping relative to another common tray on said common tray and preventing electro-static discharge.
